(19) United States
(12) Patent Application Publication
(10) Pub. No.: US 2015/0120486 A1
(43) Pub. Date: Apr. 30, 2015

(54) SYSTEM AND METHOD TO COMPILE AND COMPARE PRICES ACROSS MULTIPLE SUPPLIERS

(71) Applicants: Mark Haidet, Atlanta, GA (US); Josef Utz, Cumming, GA (US); John Heyman, Atlanta, GA (US); Karen Leytze, Cumming, GA (US); Bentley Heyman, Atlanta, GA (US); Pete Reilly, Alpharetta, GA (US)

(72) Inventors: Mark Haidet, Atlanta, GA (US); Josef Utz, Cumming, GA (US); John Heyman, Atlanta, GA (US); Karen Leytze, Cumming, GA (US); Bentley Heyman, Atlanta, GA (US); Pete Reilly, Alpharetta, GA (US)

(73) Assignee: SIFTIT, LLC, Atlanta, GA (US)

(21) Appl. No.: 14/171,327

(22) Filed: Feb. 3, 2014

Related U.S. Application Data
(60) Provisional application No. 61/898,411, filed on Oct. 31, 2013.

(51) Int. Cl. G06Q 30/06

(52) U.S. Cl. CPC G06Q 30/0611
USPC 705/26.4

(57) ABSTRACT

A computer-implemented method and system that allows operators to compile and optionally compare prices across multiple suppliers. The system and method may be based on operator preferences and may be designed to execute orders from a single database and operator interface. The system and method also facilitate the ability to compare pricing and track historical variations and trends across like products and across a plurality of suppliers by a data mapping structure.

This application claims the benefit of U.S. Provisional Patent Application No. 61/898,411, filed on Oct. 31, 2013, which is hereby incorporated by reference for all purposes as if fully set forth herein.

### BACKGROUND OF THE INVENTION

1. Field of the Invention

The present invention relates to a system and method to compile and compare prices across multiple suppliers in the food service industry.

2. Discussion of the Related Art

The food service industry is dominated by local and regional food service operations (“operations”), including but not limited to restaurants, bars, hotels, cafeterias, food trucks, entertainment facilities, catering outlets, and bakeries. The operators purchase their goods and supplies from a varied set of national, regional and local manufacturers, producers, farms and distributors (“suppliers”).

This is a highly fragmented industry that has resulted in a lack of consistent business practices, data structures and technology for how operators purchase from their suppliers. The result is a lack of actionable data for both operators and suppliers, high cost of sales for suppliers to reach and service the market, lack of comparable information for operators to make purchasing decisions, and manual processes that create cost inefficiencies and waste across the supply chain.

The lack of common data standards and structure in the industry, combined with the prevalence of manual processes, results in a lack of sufficient information for operators to effectively manage their supply chain and understand its implications on their business. As an example, it is nearly impossible for operators to identify like items across multiple suppliers for purposes of price comparison due to unique product descriptions, non-standard package sizes, and no common units of measure for pricing.

The current purchasing and inventory management solutions in the industry are primarily targeted to larger multiunit operators and are structured around ordering items from a set supplier based on a pre-negotiated price. These organizations typically leverage a dedicated, outsourced purchasing professional to negotiate prices with suppliers based on various factors. The available solutions manage the order communication across this process, track history and allow for audit of contract prices. Currently, there is no solution that allows operators to gather price data from multiple suppliers and place orders through a single tool using comparison rules. As a result, it is difficult for smaller independent operators or regional chains to simplify and optimize the supply chain processes in their business. Thus, there is a need for the ability to provide such a solution that can deliver significant value to operators in the form of time savings, comparative shopping during the ordering process, improved buying leverage and ongoing data to improve their decision making.

### SUMMARY OF THE INVENTION

Accordingly, the present invention is directed to system and method to compile and compare prices across multiple suppliers that substantially obviates one or more of the problems due to limitations and disadvantages of the related art.

An advantage of the present invention is to provide a time savings solution to gathering and comparing price data from multiple suppliers.

Another advantage of the present invention is to provide comparative shopping.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, A non-transitory computer readable medium comprising a routine configured to manage an operation ordering cycle wherein the routine when executed on a computer causes the computer to create an operation profile, import and parse through supplier items information including one or more items description and items pricing, store item description and item pricing in separate correlated databases, generate an order sheet based at least on information from the correlated databases, send an order request for purchase of one or more supplier items to one or more suppliers, compare the order sheet with information regarding delivered supplier items by an operation based on input by an operator, generate a report based on the comparison, said report identifying any discrepancy in cost between a value of supplier items received and supplier items listed in the order sheet, update an order history database based the report, and evaluate inventory of operation based on order history and a calculated amount of inventory used.

In another aspect of the present invention, a computer system comprising a first database for storing an operation profile; a second database for storing one or more supplier items files, wherein each supplier items file includes item descriptions for all items sold by a particular supplier; a third database for storing an operation items file and an operation price file, wherein the information included in the database relates only to a given operation and wherein the operation times file includes items requested for purchase and wherein the operation price file includes price information for the items included in the supplier items stored in the second database; a processor configured to correlate for those items including in the operation items file the item description stored in the second database with the prices included in the operation price file stored in the third database; a user interface configured to receive input information regarding desired quantity of operation items; the processor further configured to generate an order sheet listing a set of supplier items and correlated price information wherein the supplier items are selected to correspond to those operation items that most closely match the items in the supplier items file and with the lowest correlated prices and including the total cost of the order based on the inputted information regarding desired quantity of the operation items; to receive information regarding received supplier items, comparing said information regarding received supplier items to the supplier items listed in the order sheet and generating a payment report, wherein the third processor is further configured to update an order history database based on the payment report; and to identify actionable issues and provide alert notifications.

In another aspect of the present invention, A method of purchasing operation items from suppliers comprising creating an operation profile via a network interphase based on operation information collected from an operator of an operation; storing one or more central databases with items description received from one or more suppliers, wherein each central database includes only items description from one supplier; compiling operation specific databases with one or more supplier items operation price information received from one or more suppliers and storing such compilation in memory; correlating items description from the one or more central databases to each one or more supplier items operation price information; collecting order information from an operator via a network interphase, wherein the order information includes one or more supplier items; generating an order sheet for the one or more supplier items included in the order information by selecting for each one or more supplier items included in the order information at least one item from the one or more supplier central databases that most closely match the order information and has the lowest correlated operation price; sending the generated order sheet for each one or more supplier items to at least the supplier associated with the central database that includes the selected item; and generating a payment notice report upon receipt of confirmation of delivery supplier item to operation.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an overview of an exemplary embodiment of an order management cycle.

FIGS. 2A-2F are block diagram illustrations of exemplary embodiments of the different operations that may be executed to accomplish the order management cycle shown exemplified in FIG. 1.

FIG. 3 shows an exemplary completed order sheet.

FIG. 4 illustrates an exemplary embodiment of a general data structure that may be used in the system of the present invention.

FIGS. 5A-5F are block diagrams illustrations of exemplary embodiments of engines that may be used in implementing the system of the present invention.

### DETAILED DESCRIPTION OF THE ILLUSTRATED EMBODIMENTS

Reference will now be made in detail to an embodiment of the present invention, example of which is illustrated in the accompanying drawings.

An exemplary embodiment includes a computer-implemented method and system that allows operators to compile and optionally compare prices across multiple suppliers. For purposes of this disclosure, an operator is one acting for one or more food service operations (“operations”), such as restaurants, bars, hotels, cafeterias, food trucks, entertainment facilities, catering outlets, and bakeries. The list of operations should not be viewed as limited; operators of other food service businesses are also considered to fall within the scope of this disclosure. The system and method may be based on operator preferences and may be designed to execute orders from a single database and operator interface. The ability to compare pricing and track historical variations and trends across like products and across a plurality of suppliers may be facilitated by a data mapping structure. Such data structure may be created on a general basis to facilitate product matching and reporting across product, item and supplier.

In an embodiment, the system may be configured to import items and/or pricing from an operation's suppliers, apply rules for product and supplier preferences and determine the preferred routing of orders to suppliers. Upon configuration, an operator may then be able to efficiently place orders by simply entering desired quantities and have the system generate one or more recommended orders for each respective supplier based on the price comparison and operator preferences. They system may also be able to deliver the orders to the respective suppliers. In an exemplary embodiment, the system may also provide the operator with the ability to override the recommended orders and in real time show the impact of any change made.

Supplier price quotes and all of an operation's order history may be stored confidentially in a database with associated mapping. Such compilation of data may be used to track order history and price trends for individual operators. The system may also use this compilation of data in the aggregate to provide market information such as price trends by item across suppliers and in relation to outside factors such as commodity pricing. This compilation of data may also be used to create actionable reports and alerts to the operator including suggestions for product substitutions, bulk order discounts, opportunities to adjust menu pricing, tracking of rebate programs. The comparability and analysis of the data may be accomplished by the creation of and mapping to a unified data structure that may incorporate both general product categories as well as detail item attributes, like size, grade or section. In an exemplary embodiment, the data structure may also enable intelligent grouping of known and/or potential substitute items to align with specific operator preferences.

The ability to automate the ordering process inclusive of supplier price quotes and operator selected quantities enables a closed loop process. For example, in an embodiment, the operator's order may be used both as the purchase order and as a delivery confirmation and may also include an option to annotate any potential exceptions. Similarly, the electronic receipt of an invoice from a supplier may also be used for automated matching and can be used for handling exceptions to the purchase order, receipt of goods, or invoice detail, such as rebates. With a single tool and database to capture the order, generate a receipt and ultimately complete payment for the goods, an operator may be able to quickly track inventory and inventory valuation by simply updating on hand quantities. In an exemplary embodiment the system may also derive quantities used and apply historical pricing to valuation.

In an exemplary embodiment, a fully automated ordering process may also provide suppliers with an opportunity to better reach and market to operations. For example, the automated system may maintain standard or custom price lists, track order history for various operations in total versus single purchases with the supplier and create promotions during the ordering process targeted to the different operations and thus improve penetration, margins and ultimately customer satisfaction.

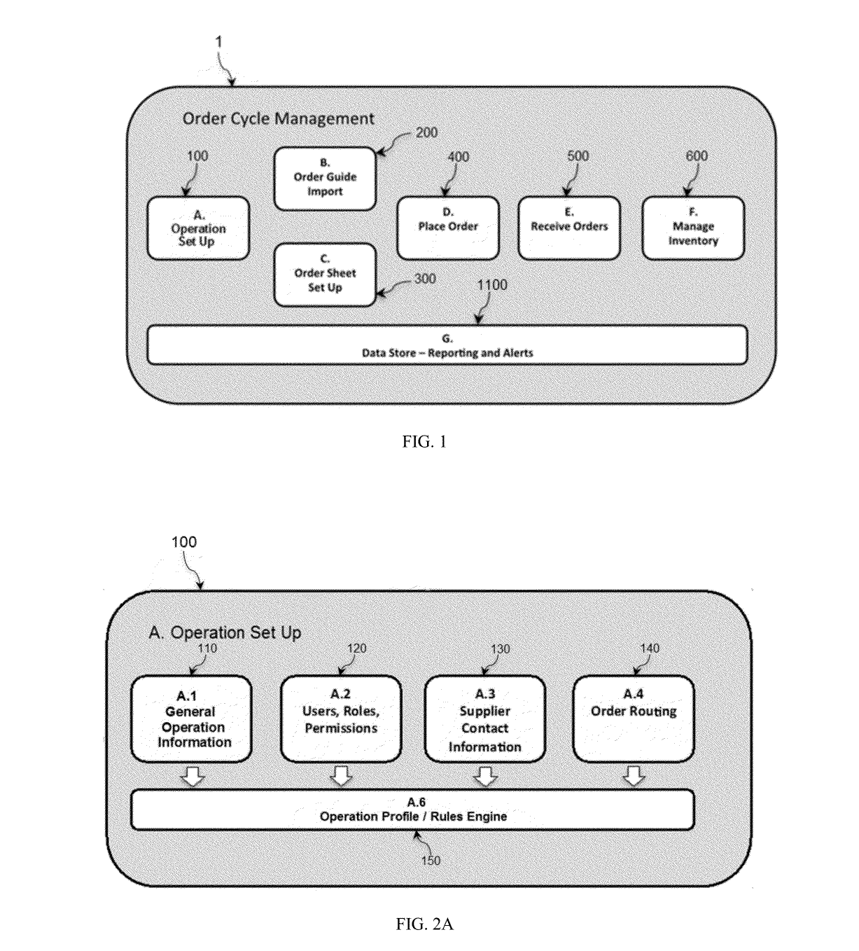

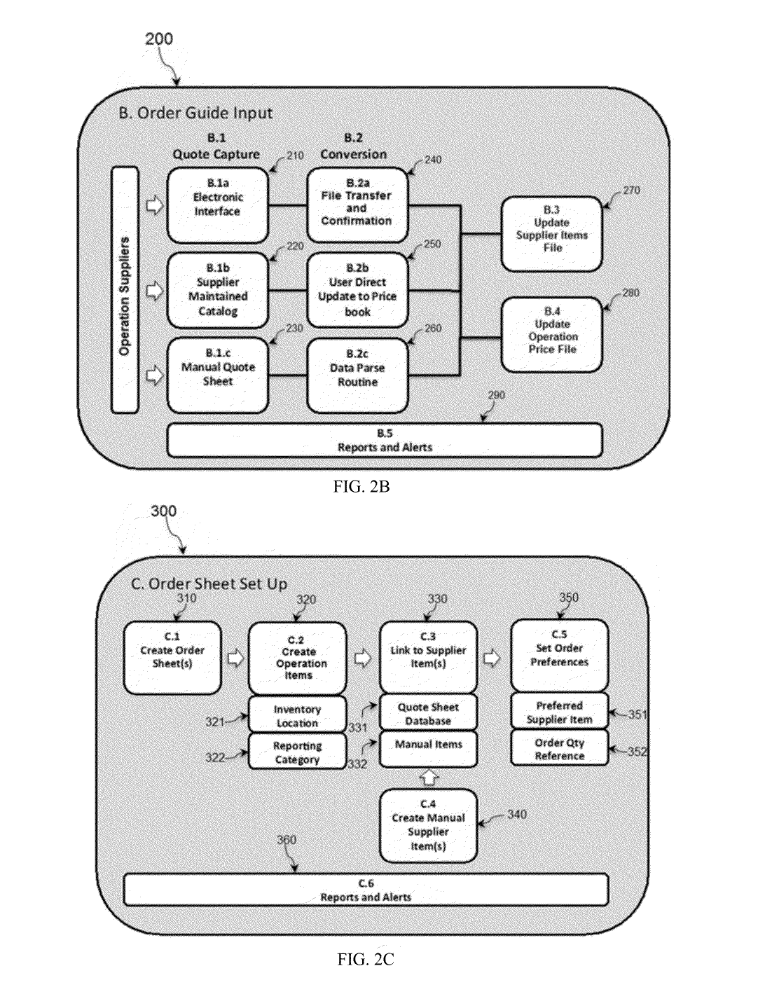

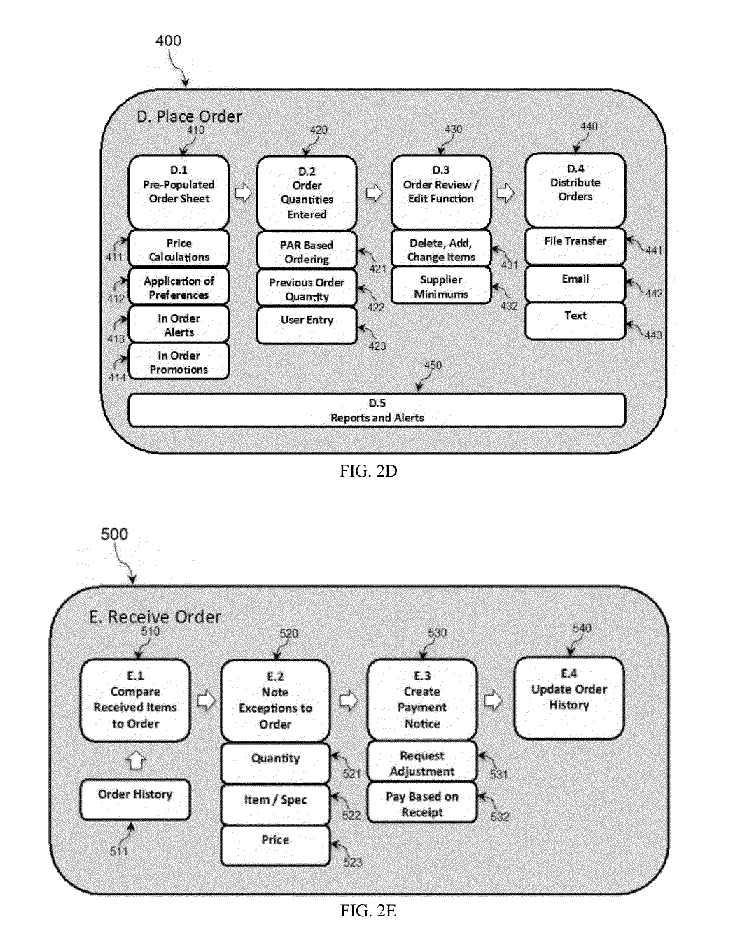

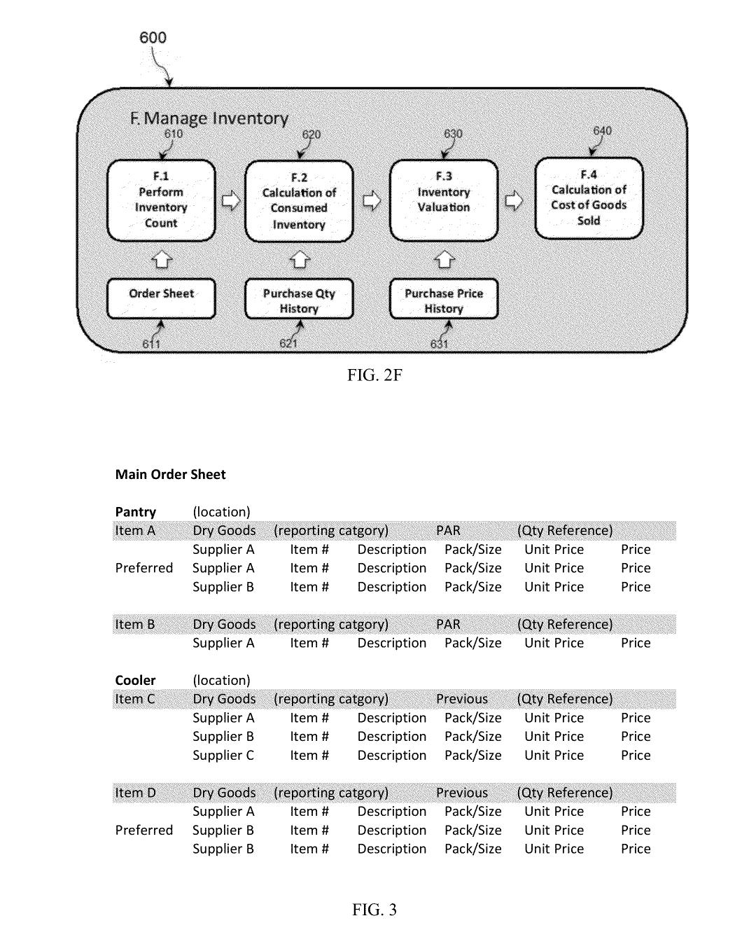

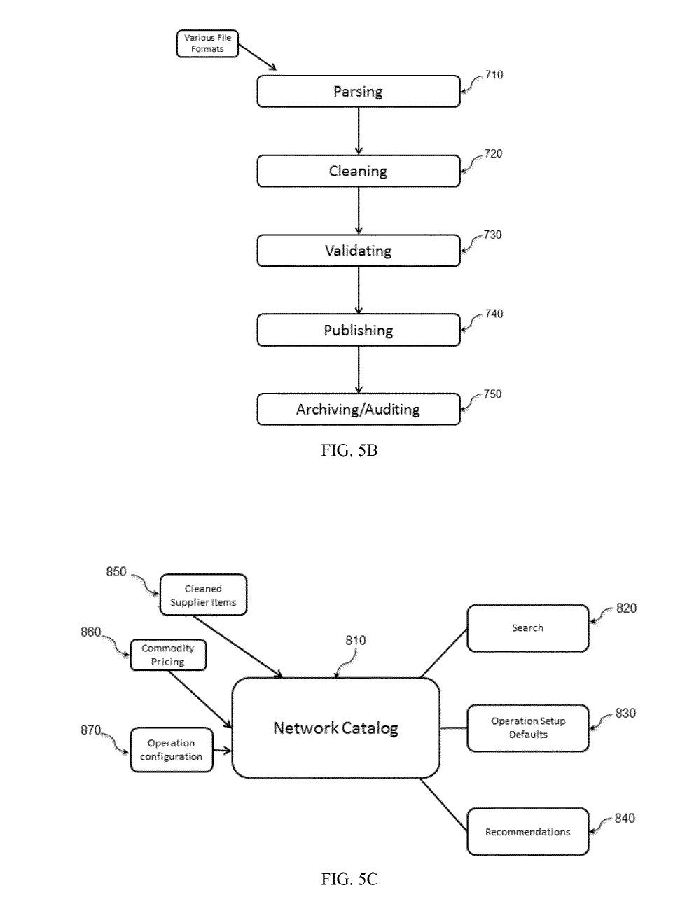

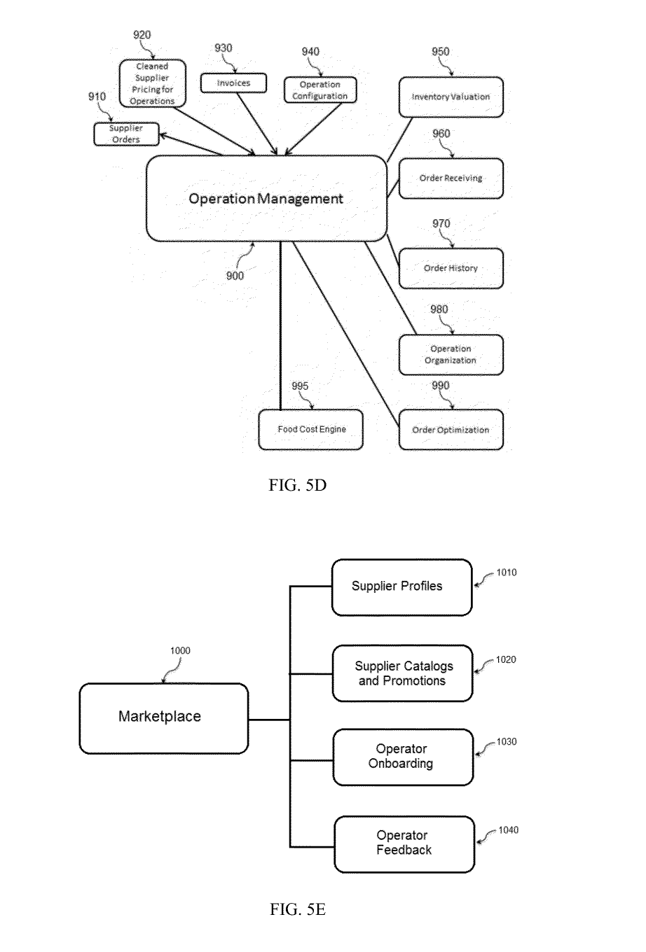

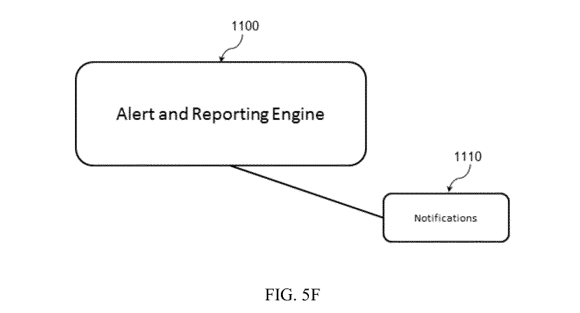

FIG. 1 shows an overview of an exemplary embodiment of an Order Management Cycle. The process may be centered on a computer-implemented method. Operators may use the process to compile and compare prices across multiple suppliers based on their preferences and can execute orders from a single database and operator interface. The components of FIG. 1 are described below in more detail in conjunction with FIGS. 2A-2F and 5F.

In an exemplary embodiment shown in FIG. 2A, using process 100 operators may set up their operations profile and rules engine 150. This may be done, for example, by entering the information into the system via a user interface. Either a mobile device or desktop computer may be used. In an exemplary embodiment, the system may be accessed via a mobile application that may be designed also to enter the information. In an exemplary embodiment the information may be entered via internet using a general purpose computer. The inputted information may provide general business information 110, set up operators and administration rights 120, provide supplier contact information 130 and rules for order routing settings 140. Additional information may also be entered to further define the operation and/or supplier. For example, the operators may customize the application for their operations and create an initial link to suppliers and to the suppliers databases using customer account numbers and suppliers contact information. In an exemplary embodiment, each operation set up data may be maintained in that operation's database and constitute the base data for the ordering rules engine by that operation. The database may be stored in any suitable memory device such as RAM, a hard drive or like devices.

An advantage of an exemplary embodiment of the system of the present invention may be the consolidation of order guides from multiple suppliers who do business with one operation. Each supplier typically maintains their own price book, often with unique pricing per customer. Other suppliers may provide standard pricing or pricing tiers for all of their customers.

FIG. 2B shows an exemplary Order Guide Input 200 is a process that may facilitate the capture, conversion and secure storage of supplier data. An order item guide, such as a list that provides item information and a price quote for each item may be captured from each supplier through various methods. Exemplary embodiments on how to capture the information are discussed below. These methods, however, should not be viewed as limited and are only provided as exemplary embodiments. Any suitable user interface device may be used to provide the information.

An exemplary method to capture an order item guide and price quote from a supplier may be by Electronic Interface File Transfer. In this exemplary method, a supplier may be able to provide the information in a predetermined file format using electronic interface engine 210. The file may contain key data elements including customer account number, items, item numbers, item information such as brand, pack size, units of measure, price and more. In an exemplary embodiment, engine 240 may then be employed to transfer the information and allow for confirmation of proper transfer. Once transferred, the file may be converted by the system and the information imported to create or update a suppler items file 270 and to the update the operation price file 280 of one or more operations.

Another exemplary method to capture an order item guide and price quote from a supplier may be Supplier Maintained Catalog 220. In this exemplary embodiment, suppliers may maintain a price catalog in the system either by operation account number or in the aggregate. Engine 250 may be designed to allow for updating an item guide and price quote by the supplier via a user interface that allows direct access to the information. In an exemplary embodiment, access and authorization to edit by any one supplier may be limited to information of that specific supplier. In an exemplary embodiment, access to all information may also be provided to a system administrator that may correct errors or other database exceptions. The updated information may then be used to create or update a supplier items file 270 and to update the operation price file 280 of one or more operations.

In yet another exemplary embodiment, the order item guide and price quote information from a supplier may be obtained by a Manual Quote Sheet 230. In this embodiment, a supplier who is unable or unwilling to provide file transfers or directly maintain their information on the system, can manually provide quote sheets that may be uploaded into the system using interface engine 230. The quote sheets may include item guide information and price quotes. The quote sheets uploaded through engine 230 can be in different formats, such as Excel price files, PDF documents, Word documents or other types of formats that can be provided by the supplier. In exemplary embodiments, the quote sheets may even be in non-electronic formats, such as paper lists or the like. The quote sheets may then be converted to electronic files if necessary, and uploaded through engine 230. Once uploaded the quote sheets may be processed using routine 260 and used to create or update that supplier items file 270 and to update the operation price file 280 of one or more operations. In an exemplary embodiment, processing of the information may be performed using a data cleaning engine as described in more detail in conjunction with FIG. 5B. A processing routine 260 may be based on a defined set of rules according to the specific supplier so that it may be able to interpret the data in the provided format and properly able to populate the database. In view of the transfer of information, an exemplary embodiment of processing routine 260 may also include a review process to ensure the information is properly transferred and may allow for manual edits if necessary. An exemplary embodiment of a processing routine 260 may include parsing, cleaning, validating, publishing and archiving/auding tools as described in further detail in conjunction with FIG. 5B below.

In an exemplary embodiment, supplier items for each supplier may be centrally maintained for each supplier in a suppler items file 270 unique to that supplier. The supplier items file may be an accumulation of data from the different order item guides provided by the supplier for the different operations. Each operation price file 280 instead may be maintained separately for each operation and can be made available only to the assigned operation. An operation price file 280 provided to each operation may be linked to the one or more supplier items files 270 to keep items detail and prices from different suppliers synchronized for use by specific operations ensuring that the data is both consistent and secure. Any suitable memory device such as RAM, hard drive or like devices may be used to store the supplier items file 270 and operation price file 280.

In an exemplary embodiment, the order guide input process 200 may also include a reporting and alert engine 290 that can create reports and alerts during import of supplier information described previously to address potential errors, exceptions, and/or improvement opportunities. An exemplary embodiment of an alert and reporting engine 290 is further described below in conjunction with FIG. 5E. For example, an exception report may be created for supplier items that have changed description or pack size. Another example may be identifications of new items. In yet another example, alerts may be created for missing price updates for items in the supplier item database.

Once the one or more supplier items files and operation price files are set up, via a user interface an operator may set up an Order Sheet as exemplified by the order sheet set up process 300 illustrated in FIG. 2C. An operator may access a create order sheet engine 310 as illustrated in the exemplary embodiment of FIG. 2C to setup operation-specific structuring of the ordering process and establish rules that may be used by an ordering recommendation logic. An advantage of this exemplary embodiment is the high degree of control and custom configuration by the operator to allow them to purchase to their specifications with their suppliers based on their preferences.

Order sheets may be set up by an operator based on the nature of their ordering process. In one embodiment, the operator may simply use a single order sheet for all its needs. In an alternative embodiment, the operator may be able to set up different order sheets to more closely reflect the purchase activity of different ordering cycles. For example, a primary order sheet may be used to cover the orders an operation may place on a bi-weekly basis across suppliers for various items such as spices and napkins. In another example, a daily order sheet may instead be set up to place daily orders of fresh ingredients, like meat and produce. Each type of order sheet may also be associated with a customizable order sheet name or identification. Thus, allowing an operator to easily recognize and access the various order sheets.

In an exemplary embodiment, the order sheet set up process may include an Operation Items engine 320 that is able to create and maintain an operation items file. In exemplary embodiments, an operation items file may include various information for each operation item. For example, each operation item may be assigned an inventory location 321 and/or a reporting category 322. The inventory location would enable an operator to group operation items by their location at the premises of the operation. This may provide a streamlined ordering process when for example using a mobile device to place orders because it could allow to enter order information while the operator walks through the storage locations of the operation. This could save time and avoid the need of manual data re-entry. Reporting categories can be helpful when preparing budget versus cost reports and in monitoring trends by type of purchases. The operation items file may be stored separately or in a central database using any suitable memory device as described herein. In an exemplary embodiment, a central database for each operation may include the operation items file along with the respective operation's one or more operation price files supplied by one or more suppliers.

The operation item file may be accessed by the create order sheet engine 310 during creation of an order sheet. For example, as described above, the information from the operation items file may provide guidance on ensuring that the operator checks all potential items to order. The operation items file may also be used by link to supplier items engine 330 to link the items selected on the order sheet to the information provided in supplier items files and operation price files.

In an exemplary embodiment, based on the operation items an operator has entered in creating an order sheet, link to supplier items engine 330 may be used to match each operation item listed on an order sheet to one or more supplier items from one or more supplier items files. In one embodiment, engine 330 may include a search routine to search the one or more available supplier items files to automatically identify and list all supplier items that meet the items on the order sheet. In an exemplary embodiment, the search results from engine 330 may be stored in quote sheet database 331. In an exemplary embodiment, the search results may also be ranked based on their level matching and/or other information provided by the operator. For example, the most closely matched items based on the operator's criteria may be made to appear at the top of the list. In another example, the most closely matched items may be based on linking patterns of other operators in the network who use similar items. This determination may be made by a systematic evaluation of patterns using the network catalog FIG. 5C data consolidated across operators. This may allow the operator to focus on the items from the one more suppliers that more closely match the operation items on the order sheet.

In one embodiment, order sheet set up routine may also include create manual supplier items engine 340 in the event an operation item from the order sheet is not found in any supplier items file. Engine 340 may be used to provide an interface through which an operator can manually set up a supplier item and trigger a request to the supplier to update the information including future price quotes. A list of manually entered items 332 may then be generated from supplier items engine 340 and stored in a database using any suitable memory device as described herein.

In an embodiment, the order sheet set up routine may also include a set order preferences engine 350 that allows an operator to set preferences on how to manage the data when operation items from the order sheet are matched with more than one supplier items. For example, order preferences engine 350 may allow the operator to set a default or preferred suppliers 351. The order preferences engine 350 may also allow the operator to set up a field to assist with streamlining the ordering process. For example, order preferences engine 350 may allow an operator to set an order quantity reference field 352 that could signal to the system a par inventory quantity to keep on hand or to opt by default to a previous order quantity. Based on these preferences, the order sheet may be modified to best match the operator's request. It should be noted that the system also allows the operator to establish an override command for other order optimization or recommendation routine described in more detail later that may also be used in conjunction with the placement of the order as described in exemplary embodiments. For example, selection of a preferred vendor could override price optimization that could otherwise be provided by an order recommendation logic.

In an exemplary embodiment, the order sheet set up process 300 may also include a reporting and alert engine 360 that may be able to create reports and alerts during the creation of an order sheet to address potential errors, exceptions or improvement opportunities in the set up process. For example, an alert may be provided for operation items that are set up but have not been linked to a supplier item from the supplier items file. Additionally a report may be made available to highlight all operation items that only have one supplier item linked to them from the supplier items list. This type of report may be helpful by signaling the opportunity to add supplier items for competitive pricing.

FIG. 3 shows an exemplary completed Order Sheet with the various data components discussed above.

In an exemplary embodiment, the information entered in completing the order sheet set up process may be used to ultimately establish the rules that drive a recommendation logic during the ordering process. The information entered, including operator order preferences and rules may be stored in any suitable memory device as described herein. Also, the system may be designed to allow an operator to access and modify any previously entered information and update their order sheet set up. Input and modification of the information may be performed using a user interface as generally described herein.

In exemplary embodiments, after initial order sheet set up, an order may be placed using any web-enabled device. In exemplary embodiments, the web enabled device is a computer such as a desktop. In alternative embodiments, the web enabled device may be a mobile device such as a laptop, smart phone, tablet or like devices. Using a mobile device may provide a more efficient manner to place an order. For example, an operator may place the order while walking through the various storage locations in the operation, determining order quantities to input based on the on-going visual inspection.

As illustrated in an exemplary embodiment shown in FIG. 2D, an operator may be able to place an order using place order process 400 and have the system segregate and distribute individual orders to each of the specific suppliers. For example, an order may be placed using an pre-populated order sheet created by a pre-populated order sheet engine 410. In an exemplary embodiment, the optimized pre-population of an order sheet may be achieved using a recommendation logic that may take into account the operator preferences 412 along with price calculations 411 to be performed by the system. In an exemplary embodiment the recommendation logic may be executed by a computing device such as one or more servers. In an embodiment, the recommendation logic may also be able to account for supplier and manufacturer promotions 414 and other order alerts 413 such as incentives, rebates, and other like supplier promotions. Specifically, based on entered information such as operation items file, supplier preferences if any, and like information, the recommendation logic may be designed to pre-select supplier items from one or more supplier items lists from one or more suppliers taking into account information stored in the operation price file so as to achieve a lowest cost possible while still meeting any pre-entered operator preferences. In such exemplary embodiment, an operator may efficiently place an order based on the recommendations provided by the recommendation logic without having to continually compare prices or review the various products from the supplier items file.

In exemplary embodiments, an operator may simply enter quantities of operation items needed using engine 420. The required quantity may be determined and entered in different ways and should not be viewed as limited. For example, the required quantity may be based on par levels 421. Alternatively, the required quantity may be based on previous orders 422. In yet an alternative embodiment the required quantity may be inputted through manual entry 423. Selection of the required quantity may be made through any suitable user interface.

Once the order quantity has been entered and the order is complete, the system may be designed to include a review and modification engine 430. Review and modification engine 430 may provide an operator the ability to review and modify the order in various ways. For example, review may be done by showing a report on a screen. The format of the report is not limited. The review may also be performed in other manners such as via a printout report or even via sound. In one exemplary embodiment, the system may be equipped with means to communicate the order contents via a speaker.

The review process may also reveal any supplier restrictions 432, such as minimum order quantities, target delivery data and total purchase. In an exemplary embodiment, a review and modification engine 430 may also include a modification subroutine 431 that may provide an operator with an opportunity to adjust the order by adding or deleting items, changing quantities, substituting products, or substituting suppliers.

Once the order has been finalized by the operator, the system may be designed to include a distribute order engine 440 that is able to send respective orders to each supplier. In an exemplary embodiment, the system will be able to send separate and individualized orders to each supplier from which the operator has requested an item. In one embodiment where all requested items come from the same supplier, the order will only be sent to the one supplier. In an alternative embodiment in which different selected items come from different suppliers, an order may be sent to each supplier requesting those items that supplier is to provide. The manner in which the orders are sent to the supplier is not limited and may be tailored to meet the communication protocol agreed to with the supplier. In an exemplary embodiment, the orders may be sent via file transfer 441. In an alternative embodiment, the orders may be sent via electronic mail 442. In yet alternative embodiments the orders may be sent via text messaging 443. Additional methods may also be employed. For example, the orders may be sent via facsimile. Alternatively, the orders may be printed and mailed to the suppliers. In exemplary embodiments the orders may also be sent in more than one format to ensure delivery.

In an exemplary embodiment, the order distribution process may also allow for confirmation of order receipt by the one or more suppliers and may update the status of the order for both the one or more suppliers and any supplier out of stock notices.

In an embodiment, the place order routine 400 may also include a reporting and alert engine 450 that is able to create reports and alerts to address potential errors, exceptions or improvement opportunities. For example, during the order, items with material price variances from the previous order may be highlighted, as may be items with out of date price information. The operator may also be given access to reports such as order history by item and the price impact of the operator preferences imposed on that item. Reporting and alert engine 450 may also be used to provide rebates or other credit information based on past order history.

As shown in an exemplary embodiment FIG. 2E, a system may also include a Receive Order routine 500. Once the ordered items are delivered by the one or more suppliers, the operator may use the order receive routine 500 to track receipts against the order history 511 using engine 510. Using a suitable user interface as described herein, an operator may access the system to open the previously submitted order sheet and mark items as received or note any exceptions to the order using engine 520. Exemplary exceptions may include inconsistencies between placed order and delivered goods such as differences in quantity 521, price 523 or item specification 522. The system may also include an engine that allows an operator to note rejection of one or more items or to request adjustment of the record for invoice and payment purposes. Once the annotations or confirmations have been entered based on inspection of the received items, Receive Order routine 500 may generate a report using create payment notice engine 530 reflecting receipt confirmation and any appropriate modifications. In an embodiment, the report created by payment notice engine 530 may be used as documentation for payment that the system can use to generate a request for invoice. Payment notice engine 530 may also include sub-routines 531 and 532 designed to reflect payment and/or request any desired adjustments reflecting any credits or other modifications based on variations of the received items. In an embodiment, the payment notice report may also be used by update order history engine 540 that can transfer the information to an order history database 511 so as to either create such database or to simply update it if previously created. The order history database may be stored using any suitable memory storage device as described herein. In exemplary embodiments, the order history database may be used to provide a final record of the purchase and may be used by the reporting and alert engine 450 for future reporting on supplier performance and credit tracking.

In an exemplary embodiment illustrated in FIG. 2F, the ongoing use of the system for purchases may allow operations to create a core database that can be used in a Manage Inventory routine 600. This routine may assist in managing and evaluating an operation using an inventory count engine 610, calculation of consumed inventory engine 620, evaluation of current inventory engine 630 and calculation of cost of goods sold engine 640. In an embodiment, update of inventory may be done using engine 610 similar to the one used during set up for ordering wherein an operator may perform a physical count of the inventory and enter the items into an inventory database. Engine 610 may also include information from order sheet 611. The system may further include engine 620 that retains the previous inventory count, adds purchases made/received in the system based on purchase history 621 and compare the inventory count to the inventory information entered by the operator to calculate the inventory used during a given period of time. Using the actual purchase price history 631, and the information from engine 620, engine 630 may then update an inventory value that engine 640 can use to calculate the cost of goods sold using any preferred valuation accounting method selected by the operator.

All supplier price quotes, operator order history, receipt and inventory information data may be stored in a database with its associated mapping. Such compilation of data may allow for ongoing tracking of order history and price trends for individual operations and may optionally be aggregated to show market price trends by item across suppliers and in relation to outside factors such as commodity pricing. This data may also enable further actionable reports and alerts to the operator including suggestions for product substitutions, bulk order discounts, opportunities to adjust menu pricing, tracking of rebate programs and so on. The comparability and analysis of the data may be enabled by the creation of and mapping to a unified data structure. In an embodiment, this unified data structure may incorporate both general product categories as well as detail item attributes. The unified data structure may optionally further allow for intelligent grouping of both known and potential substitute items to align with specific operation preferences.

In exemplary embodiments, the system and method described herein may involve multiple operations and multiple suppliers. In such embodiments, the system would in effect be able to create a closed virtual market place providing efficient exchange of information between suppliers and operations, improve suppliers' reach to various operations and the ability of each operation to compare supplier items and prices from various suppliers.

In embodiments involving multiple operations, each operation may be provided access only to that operation's information. For example a database may be created for each operation wherein the database may include that operation items file, that operation price file and operation profile information as described above. In this manner each operation may be provided with the ability to freely modify its information and automatically be updated with suppliers' price and other promotion information for the various items of interest to that operation.

In embodiments involving multiple suppliers, a database may be provided for each supplier's supplier items file. Similar to the operations databases, each supplier may be provided access to only the specific associated database so as to allow each supplier to make any necessary modifications.

Through the same process described above with respect to FIGS. 2A-2E, as the various suppliers and various operators from different operations upload respective information, enter requests, or offers such as promotions, the system may be designed to automatically update and communicate such information across all relevant databases. In this manner, the system may be able to provide improved and effective communication between the various operations and suppliers. Finally, as the number of suppliers added to the system increase, the system may be able to provide increased level of price comparison and item selection to each operation. Likewise, as the number of operations added to the system increases, the system may be able to provide suppliers with larger reach to potential customers.

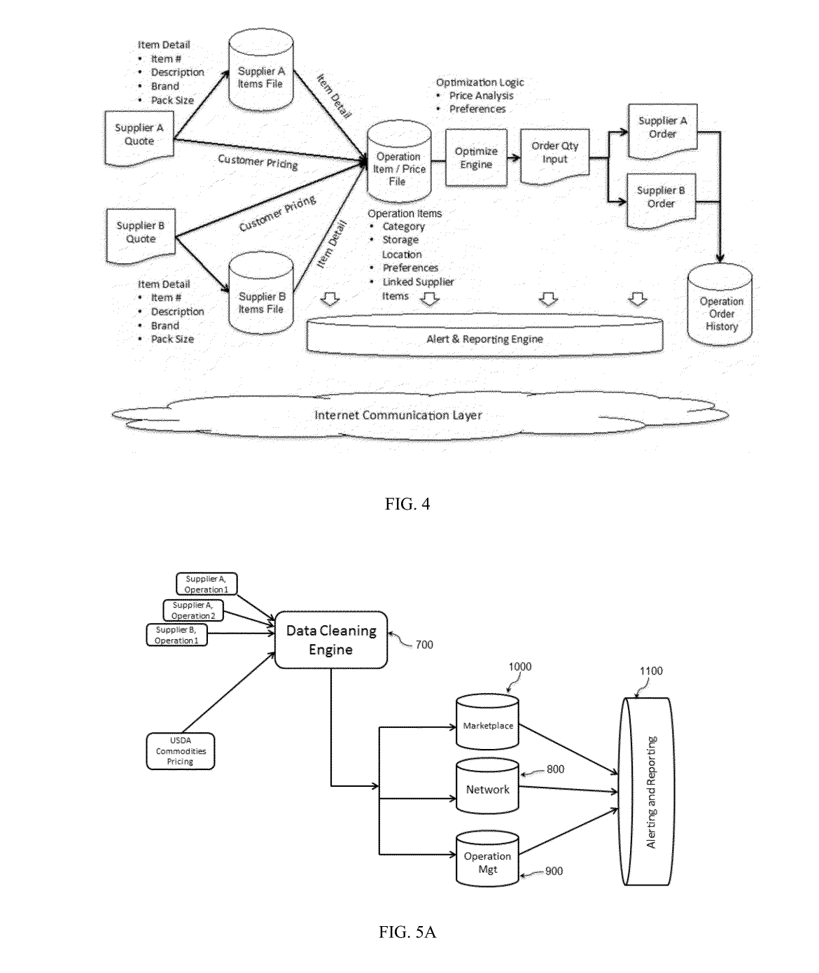

FIG. 4 illustrates an exemplary embodiment of a general data structure that may be used in the system of the present invention and that may allow for supplier order item guides and price quotes for each operation to be captured and maintained for multiple purposes with various data permissions. Supplier items may be maintained as a catalog in a central database store for use across multiple operations. The catalog may contain all data received from the suppliers including item number, description, brand, pack size, and other attributes available from the supplier. Price quotes from the one or more suppliers may also be tagged to specific operations and segregated into a separate table linked to a supplier items list database. The operation items list and operation price list may include all attribute data including location, category, preferences and supplier item links. A recommendation logic may perform and store analysis on price comparison and preferences to determine an optimal order. All order activity may be captured in a central transaction store including operator overrides, receipt of edits and inventory counts that may be used for advance system analytics and alerts. With the order quantity being determined from each supplier an order may be sent to respective suppliers. A record of placed orders may also be stored in the operation order history database. As shown, the system may also be equipped with an alerting and reporting engine and may be hosted on an internet interface.

The system may be implemented in a non-transitory computer readable medium. The entire system may optionally be centrally hosted and accessed through an Internet interface based on secure log in and permissions. Exemplary embodiments may also include the use, implementation and access to the system through mobile applications such as generally available in mobile devices like smart phones, tablets and like devices. The system and its subcomponents and logic illustrated and described herein, may include one or more components, engines, tools, applications, services, user interfaces, modules, etc. In general, the word engine (used interchangeably with the word component, application, logic, tool, service, user interface, module), as used herein, refers to logic embodied in hardware or software instructions, which can be written in a programming language, such as Java™, C/C++, PHP, Perl, PHP, HTML, CSS, JavaScript, VBScript, ASPX, Microsoft .NET™, for example. A software component, engine or application can be compiled into executable programs or written in interpreted programming languages. Software components, engines or applications may be callable from other engines or themselves. Generally, the engines or applications described herein refer to logical modules that may be merged with other engines or applications or divided into sub-engines despite their physical organization. The engines or applications can be stored in any type of computer readable medium or computer storage device and be executed by one or more general purpose computers, mobile device or the like. In addition, the methods and processes disclosed herein can alternatively be embodied in one or more engines, components, applications, or specialized computer hardware. Also, all information and databases described herein may be stored in generally available memory devices such as disk drives, flash drives and RAM. Other types of memory devices may also be used.

FIGS. 5A-5E illustrate in more detail an overview of exemplary embodiments of engines that may be used to implement the system of the present invention. FIG. 5A is an exemplary summary overview that shows a system including a data cleaning engine 700 that may be used to process all information entered into the system such as supplier information, operation information, and other relevant information such as USDA commodity pricing. The system may also include a network engine 800, an operation engine 900, a marketplace engine 1000 and an alerting and reporting engine 1100.

The infrastructure for operating the system and various engines and routines may make up the physical or hardware information technology and should not be viewed as limited to any particular arrangement. In exemplary embodiments, the infrastructure may be constituted of computer server(s), data storage, computer network, middleware, input/output systems, hypervisors, and/or database assets. The infrastructure may also include one or more central processing units (CPUs), a memory, such as random access memory (RAM), to store information temporarily or permanently, one or more input/output (I/O) devices and interfaces, such as a network interface or card, keyboard, and the like to receive or transmit data. In exemplary embodiments, the infrastructure may further comprise a storage device, such as one or more hard drives. The storage device can include one or more data repositories having a variety of structured or unstructured content, such as files and databases. The various infrastructure components may be interconnected using a standards based bus system, such as Peripheral Component Interconnect (PCI). The infrastructure used may also include various operating systems, web servers, hardware resources, and be on different network domains. Operating systems and other software may manage the various hardware resources and provide a graphical user interface (GUI) through a web server, for example.

As shown in FIG. 5A, once the information is entered into the system and processed by data cleaning engine 700, it is fed to network engine 800, operation management engine 900 and marketplace engine 1000 respectively in accordance with the specific action being performed. An alerting and reporting engine 1100 may be used to provide reporting and alerts during operation by each of the marketplace engine, network engine and operation management engine. In one exemplary embodiment, the system may use a single alerting and reporting engine for the various routines. In an alternative embodiment, the system may include two or more alerting and reporting engines. For example, each of the marketplace engine, network engine and operation management engine may include its separate alerting and reporting engine.

FIG. 5B shows a diagrammatic view of the operation of an exemplary embodiment of a data cleaning engine 700. In this exemplary embodiment, the data cleaning engine may process inputted information by parsing the entered data, clean the data, validate the data, publish the data and archive or audit the data. As discussed previously, the system may allow information to be entered in different ways. For example, as discussed in conjunction with importing supplier information, the price and item description from each supplier may be entered by way of file transfer, manual input, or by submission of quote sheets that may be provided in various formats, including non-electronic format.

Once the information is an electronic format, a parsing process 710 may be used to analyze each file, each line and each field to determine how to interpret the meaning of the data entered. Each piece of data may be appropriately catalogued so that it can be cleaned and validated. Once the inputted data has been parsed, it is cleaned using cleaning tool 720. The cleaning tool may be used to gain information about how suppliers send the information and identify any missing data, poorly formatted data, and default data. The cleaning tool may be designed to apply rules to the information received to ensure that clean data is loaded into the various engines of the system. Once cleaned, a validation tool 730 may be used to analyze the data entered and ensure its accuracy. Information that is being analyzed may include price fluctuations, unit of measure changes, pack size changes and/or other item description variations. The validation tool may also be designed to flag and alert a user of any questionable data conditions. The validated data may then be published using a publishing tool 740 that can ensure the most accurate data is available in all engines that use the data including the market place, the network and the ordering and operational engines. The data cleaning engine may also be designed to archive and audit information entered to preserve the historical data and make it available for further analysis by the other system engines.

FIG. 5C shows a diagrammatic view of an exemplary embodiment of network engine 800. A network engine may include a network catalog 810 that may be accessed by a search engine 820, operation setup engine 830 and recommendation logic 840. The various applications for these engines were described previously. Operation setup engine 830 may, for example, be employed to set up an operation profile with associated rules and operator preferences as previously discussed in conjunction with FIG. 2A. In an exemplary embodiment, search engine 820 and recommendation logic 840 may be used during completion of an order sheet as discussed in conjunction with FIG. 2C. These are simply exemplary embodiments of how these engines may be employed and should not be viewed as exclusive of other applications. The information provided to network catalog 810 may include information relating to supplier item and operation price list 850, commodity pricing information 860, and operation information 870. In an exemplary embodiment, the network catalog 810 may map available supplier items into a common structure including categories, sub-categories and attributes. The information may be maintained, for example, through data cleaning and through crowd-sourcing techniques. The power of the recommendations, defaults and search capabilities may be enhanced through relationship mapping based on actual operation usage of comparable supplier items. The additional dimension of data may allow the ability to show how real-world operators truly determine equal products across a multitude of dimensions and attributes.

FIG. 5D shows a diagrammatic view of an exemplary embodiment of operation management engine 900. In this exemplary embodiment, the operation management engine 900 may be used to send order to one or more suppliers 910 based on information received from supplier such as supplier item information and operation pricing 920, invoices 930 and operation set up 940. The operation management may also be designed to be accessed by one or more of an inventory valuation engine 950, an order receiving engine 960, order history engine 970, operation organization engine 980 and order optimization engine 990. In an exemplary embodiment, inventory evaluation tool may provide direct linking of actual orders and supplier pricing information to the operation standard inventory valuation process without the burden and mistakes that may arise from manual entry.

In some instances, operations include small, busy areas such as a restaurant kitchen, wherein receipt and control of a supplier item may be time consuming, difficult and disruptive process. To address this problem, in one exemplary embodiment, an order receiving engine 960 may be designed to communicate with operation management 900 to link the ordering process to the inspection of received supplier items process. Independent of who is handling the ordering and the checking of the various items, the system may be designed to provide for an efficient method to inspect the received supplier items and compare them against the items included on the order sheet to ensure accuracy and appropriate payment and/or credits.

Additional engines may further be given access to management engine 900 to accomplish various tasks. For example, in an exemplary embodiment, an order history engine 970 may be used to provide operations with more visibility into historical pricing, actual item usage, possible theft issues, and ultimately an ability to plan for a target menu cost and overall margin.

In an additional embodiment, an operation workflow tool 980 may be used to facilitate the operation's execution of standard and ad hoc processes. The operation workflow may combine alerts, work item tracking and system workflow to simplify the management of set up, data maintenance, data changes in the system and other system or user defined tasks. For example, operations such as restaurants may feature specials or periodic food offerings on their menu that require a set of activities to manage. These activities may include requesting price quotes for ingredients, setting up the item in the ordering database, evaluating the profit margin of the dish and updating the point of sale system for making the item available for sale. The operator under the action of a new menu item could set up the set of tasks in advance. The system could then provide the operator with a checklist of activities and track the progress of completion. For areas within the system, a defined workflow could be provided to facilitate the completion of an action. As an example, for the action of requesting a supplier quote, the user could be taken to a screen to input the request that could be forwarded to their supplier. The system would then provide an update to the user when the data has been updated in the system.

In yet another embodiment, an order optimization engine 990 may be implemented to analyze a given operation preferences, supplier prices, operation inventory needs and other requirements in order to generate an optimal order.

In an additional embodiment, a food cost engine 995 may be implemented to analyze a given menu item or prepared ingredient cost. This engine may utilize current purchase history and inventory valuation data to allow for calculation of recipes for specific servings of finished products. As an example, an operator may want to evaluate menu prices and therefore calculate the current price of a prepared dish. In this example, the operator could build a recipe with the measurement of each ingredient in a serving and the food cost engine tool would generate a current calculation of the cost of the dish. The food cost engine may also be useful to prepare this type of calculation for historical time periods or for projected costs based on commodity trends or what if scenarios.

Although these additional engines have been described in alternative embodiments, it should also be understood that combination of two or more of these tools or engines may also be implemented.

FIG. 5E shows a diagrammatic view of an exemplary embodiment of a marketplace engine 1000. This engine may include various tools. In the exemplary embodiment shown in FIG. 5E, the market place engine may include a supplier profile tool 1010, supplier catalogs and promotions tool 1020, operator on-boarding tool 1030, and operator feedback tool 1040. The supplier profile tool 1010 may allow suppliers the ability to manage a marketing page that is published to the operators on the network. Supplier profile tool may provide general information about the supplier's company and products and links to the supplier's web site. The supplier catalog and promotions tool 1020 may be designed to enable suppliers to publish product catalogs and pricing to network operators to allow for purchasing. The tool may provide suppliers with the ability to set and update prices and publish specials and promotions to network operators. Operator onboarding 1030 may be used to facilitate the process for operators to set up accounts with new suppliers to initiate commerce. Suppliers typically require new customers to set up accounts and often require credit information. The onboarding tool may allow operators to securely maintain a business profile with credit data that can be submitted to new suppliers to initiate the onboarding process. Operator feedback tool 1040 may be used to facilitate operator feedback to suppliers. Operators who have done business with suppliers could have the ability to leave private or public comments and satisfaction ratings. This information may be used by network operations to inform their decision around using prospective suppliers and may be used by suppliers to provide guidance to improve their service and address perception issues in the market. The combined components of the marketplace engine may also provide a closed loop environment for operators and suppliers to initiate relationships and transact business in conjunction with other components of the overall solution.

FIG. 5F shows a diagrammatic view of an exemplary embodiment of an alerting and reporting engine 1100. As illustrated, an alert and reporting engine may be employed to generate various types of notifications 1100. The functionality of an alert and reporting engine has already been describing previously in conjunction with various processes illustrated in FIGS. 1 and 2A-2F. In an exemplary embodiment, an alert and reporting engine may be used to provide early visibility into actionable issues including increased cost of menu items, other suppliers item options, inaccurate data and other like information. In an exemplary embodiment, an alerting and reporting engine may use a set of asynchronous engines to analyze data trends across time periods, geographies and suppliers. The analysis results may then be published in a manner that can allow operations to opt into any notifications and action wizards. An action wizard may also be used to guide a user through fixing or improving any issues that may be identified by the analysis. As shown in the illustrated exemplary embodiment of FIG. 5F, the alerting and reporting engine may be a single engine that provides all the alerting and reporting functions described herein even in conjunction with FIGS. 1, 2A-2F, and 4. In an alternative embodiment, the alerting and reporting engine may instead be comprised of separate engines, each designed for the specific alerting and reporting tasks described in each of the various applications discussed herein.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A non-transitory computer readable medium comprising:
a routine configured to manage an operation ordering cycle wherein the routine when executed on a computer causes the computer to:
create an operation profile;
import and parse through supplier items information including one or more items description and items pricing, and store item description and item pricing in separate correlated databases;
generate an order sheet based at least on information from the correlated databases;
send an order request for purchase of one or more supplier items to one or more suppliers;
compare the order sheet with information regarding delivered supplier items by an operation based on input by an operator;
generate a report based on the comparison, said report identifying any discrepancy in cost between a value of supplier items received and supplier items listed in the order sheet;
update an order history database based on the report; and
evaluate inventory of operation based on order history and a calculated amount of inventory used.

2. The non-transitory computer readable medium of claim 1 wherein to import and parse through the supplier item information the medium further comprises:
a parsing tool configured to analyze each line and each field of each file constituting the supplier information, through said received supplier information;
a cleaning tool configured to apply rules to the received information based on how a supplier provides the information;
a validation tool configured to analyze the received data and generate alerts;
a publishing tool configured to ensure the received information is available to all relevant engines within the computer readable medium; and
an archiving and auditing tool configured to ensure historical data is available for analysis.

3. The non-transitory computer readable medium of claim 1 wherein to generation the an order sheet the medium further comprises:
a network catalog engine configured to receive supplier items information, operation items pricing, and the operation profile;
a search tool designed to have access to the network catalog engine and configured to compare supplier items information with one or more requested items;
an operation set up default tool designed to have access to the network catalog engine and configured to receive and communicate operation ordering default rules; and
a recommendation routine designed to have access to the network catalog engine, the recommendation routine configured to compile an order sheet for requested supplier items in accordance with operation ordering default rules for the lowest cost.

4. The non-transitory computer readable medium of claim 1 further comprising an alert and reporting engine that uses a set of synchronous engines to analyze data trends across time periods, geographies and suppliers and provide notifications and an action wizard.

5. A computer system comprising:
a first database for storing an operation profile;
a second database for storing one or more supplier items files, wherein each supplier items file includes item descriptions for all items sold by a particular supplier;
a third database for storing an operation items file and an operation price file, wherein the information included in the database relates only to a given operation and wherein the operation times file includes items requested for purchase and wherein the operation price file includes price information for the items included in the supplier items stored in the second database;
a processor configured to correlate for those items including in the operation items file the item description stored in the second database with the prices included in the operation price file stored in the third database;
a user interface configured to receive input information regarding desired quantity of operation items;
the processor further configured to:
generate an order sheet listing a set of supplier items and correlated price information wherein the supplier items are selected to correspond to those operation items that most closely match the items in the supplier items file and with the lowest correlated prices and including the total cost of the order based on the inputted information regarding desired quantity of the operation items;
to receive information regarding received supplier items, comparing said information regarding received supplier items to the supplier items listed in the order sheet and generating a payment report, wherein the third processor is further configured to update an order history database based on the payment report; and
to identify actionable issues and provide alert notifications.

6. The computer system of claim 5, wherein the system is centrally hosted through an internet interface based on secured log in.

7. The computer system of claim 5, wherein the user interface is provided on a mobile device.

8. The computer system of claim 5, further comprising at least two supplier items files.

9. The computer system of claim 8, further comprising a fourth database containing information relating to a different operation and wherein the third database and the fourth database may be accessed only by the operation with which the database is associated.

10. The computer system of claim 5, wherein the processor is further configured to generate multiple order sheets, each order sheet listing only items for a single supplier and wherein each order sheet is for items to be ordered by a different supplier.

11. The computer system of claim 5, wherein the processor is further configured to transmit the order sheet to one or more suppliers.

12. The computer system of claim 5, further comprising a processor configured to evaluate an operation based on inventory count, calculation of consumed inventory, evaluation of existing inventory, and cost of goods sold.

13. A method of purchasing operation items from suppliers comprising:
creating an operation profile via a network interphase based on operation information collected from an operator of an operation;
storing one or more central databases with items description received from one or more suppliers, wherein each central database includes only items description from one supplier;
compiling operation specific databases with one or more supplier items operation price information received from one or more suppliers and storing such compilation in memory;
correlating items description from the one or more central databases to each one or more supplier items operation price information;
collecting order information from an operator via a network interphase, wherein the order information includes one or more supplier items;
generating an order sheet for the one or more supplier items included in the order information by selecting for each one or more supplier items included in the order information at least one item from the one or more supplier central databases that most closely match the order information and has the lowest correlated operation price;
sending the generated order sheet for each one or more supplier items to at least the supplier associated with the central database that includes the selected item; and
generating a payment notice report upon receipt of confirmation of delivery supplier item to operation.

14. The method of claim 13, further comprising:
pre-formulating a recommended order sheet prior to collecting order information relating to one or more supplier items.

15. The method of claim 13, further comprising:
updating an order history database based on the payment notice report.

16. The method of claim 13, further comprising:
collecting inventory count information from an operator, wherein inventory consists of a type of supplier items;
maintaining an inventory database for the type of supplier items based at least on order history information;
evaluating an operation based on a comparison between inventory count information and information maintained in the inventory database and the operation price for the type of supplier items.
